(19) United States
(12) Patent Application Publication
(10) Pub. No.: US 2017/0253426 A1
(43) Pub. Date: Sep. 7, 2017

(54) SELF-ASSEMBLED MONOLAYER FLOAT EVAPORATION REDUCTION APPARATUS AND METHOD OF USE THEREOF

(71) Applicants: Eric Emil Boyer, Rhome, TX (US); Sachery Peterson Boyer, San Antonio, TX (US); Axel Emil Boyer, Orem, UT (US)

(72) Inventors: Eric Emil Boyer, Rhome, TX (US); Sachery Peterson Boyer, San Antonio, TX (US); Axel Emil Boyer, Orem, UT (US)

(21) Appl. No.: 15/214,189

(22) Filed: Jul. 19, 2016

Related U.S. Application Data
(60) Provisional application No. 62/303,299, filed on Mar. 3, 2016.

(51) Int. Cl. B65D 88/34; E03B 11/00

(52) U.S. Cl. CPC B65D 88/34; E03B 11/00; H04B 7/24

(57) ABSTRACT

The invention comprises a float evaporation reduction apparatus and method of use thereof. Individual floats self-right, self-unstack, and/or self-move through elements of the float design, such as a wind redirection element and/or a stability element. In one case, floats use top-side ridges to redirect wind forces to form, interconnect, and/or stabilize a self-assembled monolayer of floats. In another case, floats use side friction/interconnection forces to stabilize adjacent floats. In another case, one float and preferably a spatially distributed set of floats gather localized information as to the surrounding environment, and/or communicate data and/or information back to a controller.

### CROSS-REFERENCES TO RELATED APPLICATIONS

This application claims the benefit of U.S. provisional patent application no. 62/303,299 filed Mar. 3, 2016, which is incorporated herein in its entirety by this reference thereto.

### BACKGROUND OF THE INVENTION

Field of the Invention

The invention relates to reduction of evaporation of a solvent, such as water, fumes, and/or toxic fumes from a storage pond.

Discussion of the Prior Art

In many regions or areas, such as a water storage pond, loss of water via evaporation is preferably minimized as water is scarce, difficult to replace, and/or is expensive.

### Floating Evaporation Barriers

Floating evaporation barriers have been used to reduce evaporation from the surface of a body of water.

Goad, C., et. al. “Floating Tank Blankets and Methods for Creating the Same on a Surface of a Liquid”, U.S. Pat. No. 8,925,754 B2, Jan. 6, 2015 describe a floating tank blanket that uses isolated floats between upper and lower sheets, where the blanket is positioned within a tank to inhibit release of fumes from the tank.

Alirol, M. “Liquid Covering Disks”, U.S. Pat. No. 8,342,352 B2, Jan. 1, 2013 describes floating disks to cover a liquid surface.

All of these systems suffer from wind blowing the water cover off of the water or piling up the water cover on the leeward side of the water surface.

### Problem

What is needed is an effective, deployable, monitorable, and recoverable system for reducing evaporation, such as water evaporation from a water holding pond.

### SUMMARY OF THE INVENTION

The invention comprises a self-arranging set of floats or capsules for reducing evaporation from a body of water and optionally using the floats to gather and relay information about an environment about the floats to a controller.

### DESCRIPTION OF THE FIGURES

A more complete understanding of the present invention is derived by referring to the detailed description and claims when considered in connection with the Figures, wherein like reference numbers refer to similar items throughout the Figures.

FIGS. 1(A-C) illustrate hexagonal floats from a top, side, and perspective view, respectively;

FIG. 2 illustrates a self-assembled monolayer of a set of floats.

FIG. 3A illustrates a float with a top-side ridge and FIG. 3B illustrates an eddy current and a resultant downward force on the leeward side of the top-side ridge;

FIG. 4 illustrates forces moving a float into a self-assembled monolayer of floats;

FIG. 5 illustrates wind induced stabilizing forces and interlocking floats;

FIG. 6 illustrates a joint between independently movable floats;

FIG. 7 illustrates wind induced interlocking, inter-float forces;

FIG. 8 illustrates float data collection and distribution;

FIG. 9 illustrates a method of float deployment, use, monitoring, recovery, and control; and

FIG. 10 illustrates stackable floats.

Elements and steps in the figures are illustrated for simplicity and clarity and have not necessarily been rendered according to any particular sequence. For example, steps that are performed concurrently or in different order are illustrated in the figures to help improve understanding of embodiments of the present invention.

### DETAILED DESCRIPTION OF THE INVENTION

The invention comprises an evaporation reduction float apparatus and method of use thereof.

In one embodiment, the floats reduce evaporation by substantially covering a portion of a surface of a body of water.

In another embodiment, the floats self-assemble into a monolayer using wind as a driving force. More particularly, wind force is transferred to top-side ridges or bumps driving individual floats together into groups or sheets. Similarly, wind force is used to interlock mating side elements of the floats to help maintain a monolayer of floats.

In still another embodiment, floats are used to gather information about their environment, where the environment information is used by a controller. For example, the floats gather data/information on any of: air temperature, water temperature, water depth, water obstructions, current, turbidity, sunlight penetration into the water, location of floats, grouping of floats, stacking of floats, theft of floats, and condition of floats. Optionally, data is wirelessly sent to a controller, such as an owner, operator, and/or a control system.

Herein, for clarity of presentation and without loss of generality: (1) liquid water is used as the liquid solvent and is representative of any fluid and (2) water vapor is used to represent the released gas, vapor, fume, or gas form of the solvent.

Beyond the components necessary for the float to float semi-immersed in water or other liquid, all of the float components described herein are optional.

Herein, an x-axis and a y-axis form a plane parallel to a water surface and a z-axis runs normal to the x/y-plane, such as along an axis aligned with gravity. The axes are relative to an individual float and are further defined as needed.

### Float

A float used in a set of floats to at least partially cover a water surface is further describe herein.

### Float Sides

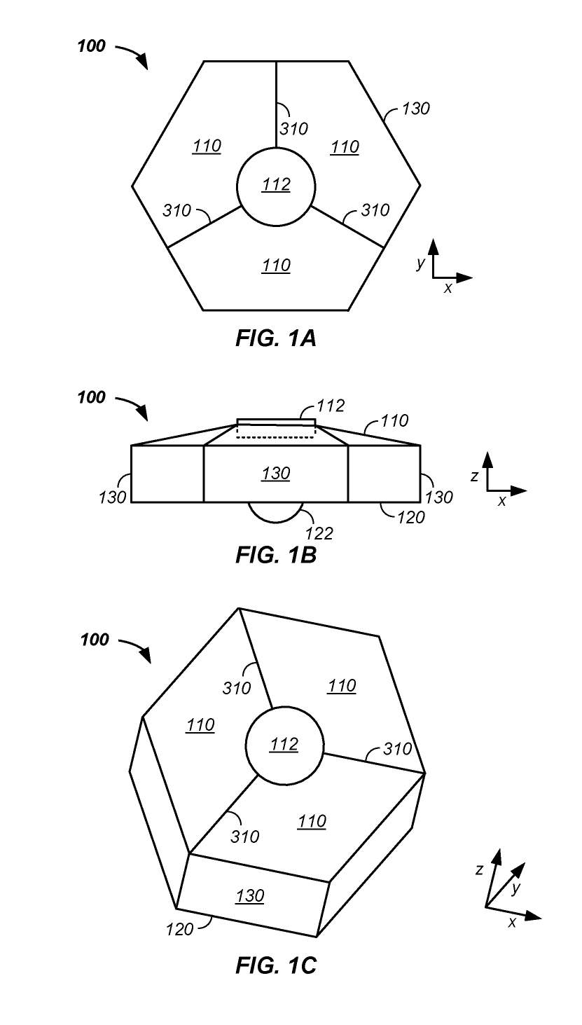

Referring now to FIGS. 1(A-C), a float 100 is illustrated. The float 100 has a top surface 110, a bottom surface 120, and multiple sides 130, such as 3, 4, 5, 6, 7, 8, or more sides 130. Generally, water surface packing efficiency is preferred making triangular, square, or hexagon shapes that closely pack and cover most of the water surface preferable to circular shapes, which do not fit closely together on the x/y-plane and thus leave room for evaporation. Shapes with a center of gravity that is not centered to the float 100 or have edges that catch the wind may result in the floats stacking vertically or even being blown off of the water surface. However, the float 100 described herein optionally has any number of sides and/or is of any geometry. For clarity of presentation and without loss of generality, the float 100 is illustrated with six sides, which is the preferred embodiment. Herein, all connections of sides are optionally intersections of planes or have rounded edges/corners, such as an inside and/or outside radius of curvature between any of 0.05, 0.1, 0.25, 0.5, 1, and 2 inches. In a first case, the float sides 130 are smooth. In a second case, the float sides 130 are notched in mating shapes, such as a tongue and groove shape. In a third case, the float sides 130 are rough to hinder wind lifting the floats. The float sides 130 are further described, infra.

### Float Top Surface

Still referring to FIGS. 1(A-C), the top surface 110 of the float 100 optionally extends upward along the z-axis as a function of distance from a perimeter of the top surface 110, such as toward a z-axis running through the geometric center of the float 100. The extension upwards is optionally a distance greater than 0.1 inch and less than 0.25, 0.5, 1, 2, or 5 inches, which allows capture of wind forces to minimize risks of wind stacking the floats 100 vertically. Referring now to FIG. 1A, the float 100 is illustrated with an optional top surface 110 that extends upwards in each of three panels, where the panels extend to an edge of the perimeter of the top surface 110. Referring now to FIG. 1C, the float 100 is illustrated with an optional top surface 110 that also extends upwards in each of three panels, but the panels extend to a corner of the perimeter of the top surface 110. Referring now to FIG. 1B, the top surface 110 of the float 100 is illustrate with an equal number of panels and edges, such as top six panels for a six-sided float. Generally, the top surface 110 of the float 100 comprises any number and any shape of panels, where the panels interconnect to form the top surface 110. The top surface 110 optionally comprises panels of varying shapes. The top surface 110 of the float 100 optionally comprises one or more ridges 310 used to self-assemble a monolayer of floats 200, described infra, and/or an optional insert 112 used in data gathering and communication, described infra.

### Float Bottom Surface

Referring now to FIG. 1B and FIG. 1C, the bottom surface 120 of the float 100 is illustrated with a flat surface. However, the bottom surface 120 of the float 100 optionally extends upwards toward the center of gravity of the float 100 or downward away from the center of gravity of the float 100 with one or more bottom side panels, in a manner similar to that described for the top surface 110 of the float 100. The bottom surface 120 of the float 100 is illustrated with an optional stability bulb 122, further described infra. The stability bulb 122 comprises a rounded or teardrop shape that extends from any panel, such as a half-sphere, but is illustrated as extending from a flat bottom surface 120 of the float 100 for clarity of presentation.

In practice, the float is optionally manufactured via molding, such as by blow molding. Optionally and preferably, the float 100 is a single piece enclosing a gas, such as air, for buoyancy of the float.

### Float Stability

Optionally and preferably, the float 100 self-rights itself after being tossed into the water 520, dumped into the water, and/or being inverted by wind. The self-righting characteristic is based upon a low center of gravity, such as resultant from the stability bulb 122, from a thicker layer of material in the bottom side 120 relative to the top side 110 of the float, through use of an internal ballast, and/or through use of different densities of material as a function of z-axis position. The lower center of gravity also reduces probability of wind and/or waves flipping the float 100. Optionally and preferably, the float 100 has a height to width ratio greater than 1:100, 1:20, or 1:10 and/or less than 1:10, 1:5, or 1:1, which aids in self-righting of the float 100.

### Float Construction

The float 100 is optionally of multi-element design; however, the float is preferably made from a single piece of cast, molded, or blown material, such as a blown plastic into a mold. The float 100 is optionally sealed, has one or more openings to one or more compartments, and/or is attached to an attachment, such as a sensor or float material. The sealed air in the float is preferably used to provide buoyancy, but any material, such as an expandable blown foam, is optionally placed in any section of the float 100. Optionally, the bottom layer of the float 100 comprises a hydrophilic material or hydrophilic coating. Optionally, the top layer of the float 100 comprises a hydrophobic material or hydrophobic coating, which aids in self-righting the float 100.

### Float Monolayer

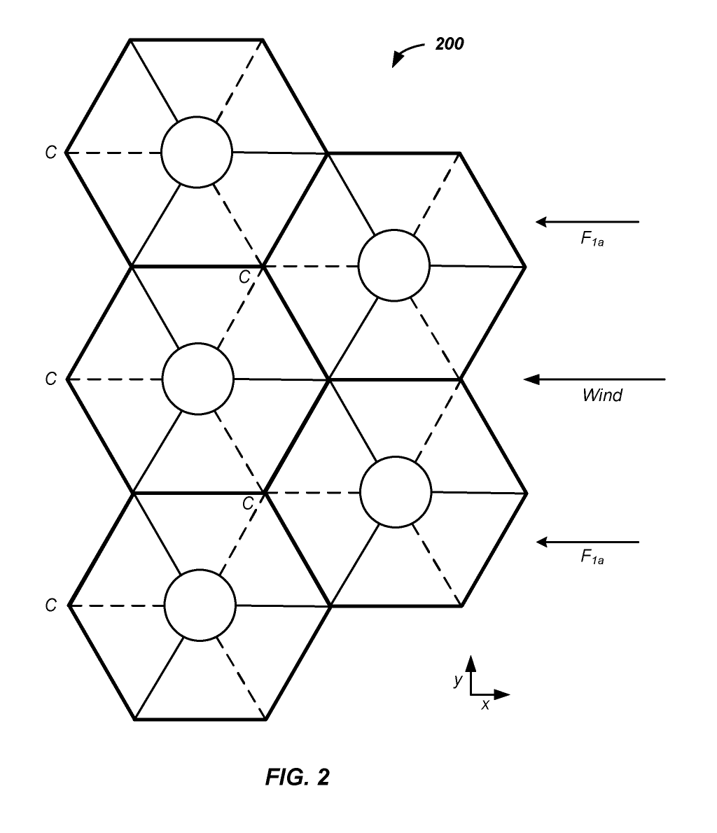

Referring now to FIG. 2, a float monolayer 200 is illustrated. The float monolayer 200 comprises a plurality of floats 100 on a surface of the water. As illustrated, the float monolayer 200 comprises a self-assembled monolayer of floats, where the floats are pushed at least horizontally using a wind force. As illustrated, a first horizontal wind force, F₁ₐ, is illustrated pushing on float sides 130 of multiple floats 100 forcing the floats to interconnect. Additional wind forces used to generate the self-assembled monolayer are further described, infra.

### Float Ridge/Float Forces

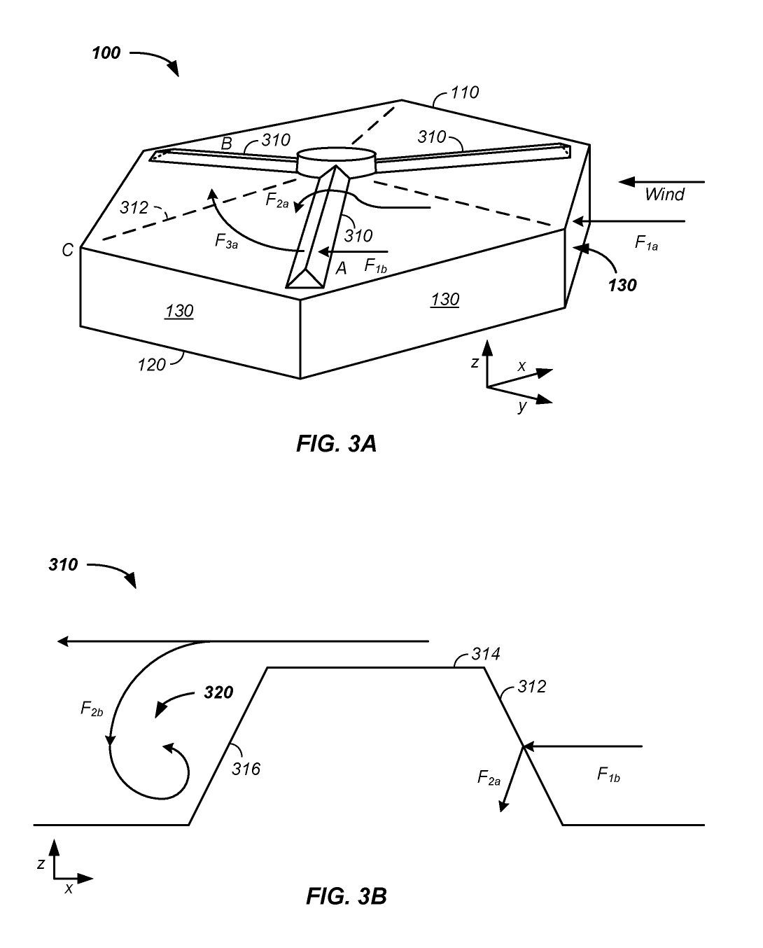

Referring now to FIG. 3A and FIG. 3B, ridges 310 of the float 100 are further described. As illustrated, a ridge 310 extends: (1) along the z-axis from the top surface 110 of the float 100 and (2) radially outward along an axis from a center of the top surface 110 of the float 100 toward an outer perimeter of the top surface 110 of the float 100. Generally, a single float 100 comprises any number of ridges 310, such as 1, 2, 3, 4, 5, 6, 8, 10, 100, 1000 or more ridges. Further, any of the ridges protrude along any axis along the top surface 110 of the float 100. Indeed, as described below, a given ridge 310 is optionally a rounded shape, such as an arc or a section of a circle, oval, parabola or a second order or higher curve. Generally, a ridge 310 is used to redirect a wind force, as described herein. The inventor notes that a mere joining of surface sections or panels, such as joint 312, is not a ridge as described herein as the ridge 310 has a wind catching property sufficient to impart movement of the float 100 and/or provide a downward force on the float 100.

Still referring to FIG. 3A and FIG. 3B, wind forces on the float 100 are further described. A wind force is illustrated interacting with a windward ridge side 312 of a ridge 310 to yield: (1) a second horizontal wind force, F_{1b}, pushing on a windward side of the ridge protruding upward along the z-axis and (2) a first rotational force, F₃ₐ, described infra. Like the first horizontal wind force, F₁ₐ, the second horizontal wind force, F_{1b}, moves the float 100 along the x/y-plane into contact with other floats in the float monolayer 200. Notably, the second horizontal wind force, F_{1b}, continues to push individual floats together even after the first horizontal wind force, F₁ₐ, on a given float is blocked by a windward float. In addition, the second horizontal wind force, F_{1b}, provides the first rotational force, F₃ₐ, or torqueing force that rotates the float 100 in the x/y-plane about a z-axis, such as through the center of gravity of the float 100. As illustrated, the first rotational force, F₃ₐ, at point A is eventually countered by a counterbalancing rotational force at point B, which causes point C to align on the leeward side of the float 100. It is recognized that the rotational forces along the ridges integrate to yield a net rotational force. Thus, the C3 rotational symmetry design will probabilistically drive one of the three non-ridged corners, such as corner C, to the leeward side of the float 100. The inventor notes that the other ridge shapes, such as a circular ridge described above, may be designed to yield a desired net rotational force. Indeed, a specified corner of the float 100 could be orientated to a specified position, such as the leeward side, with a set of ridges yielding an integrated rotation force to the specified position, such as the leeward side. The inventor, has minimized float rotation requirements as a function of changing wind direction through selection of the C3 rotational symmetry design of the ridges, which aids in the formation of a self-assembled monolayer, as described below.

Referring again to FIG. 2 and still referring to FIG. 3A, the self-assembled monolayer of floats is further described. As described supra, the layout of the ridges 310 on the top side of the float 100 probabilistically orientates one of the three non-ridge intersecting corners, such as corner C, to the leeward side of the float 100. In FIG. 2, five floats were each probabilistically aligned with corner C to the leeward side, which is not the case without the ridges as the windward side of the un-redirected float presents a flat edge section of the float 100 to the wind as opposed to presenting an intersection of two edge sections of the float 100 to the wind as illustrated in FIG. 2. Thus, rotationally aligned by the first rotational force, F₃ₐ, the first and second horizontal forces, F₁ₐ and F_{1b}, push the floats together into a self-assembled monolayer of floats, which again does not spontaneously happen without the captured wind force being redirected into rotational force. Further, the inventor notes that the first horizontal force, F₁ₐ, applies only to the windward side of a first column of floats, while the windward side of additional columns of floats is blocked by the first column of floats. Thus, designs without the rotational force capturing element of the ridge do not readily self-form a substantially uniform monolayer of floats and have multiple gaps between floats. The increased efficiency of coverage is important as evaporation reduction efficiency increases as a function of coverage of the body of water.

Referring again to FIG. 3A and FIG. 3B, downward forces on the float 100 are described. As illustrated, the wind striking a windward ridge-side 312 of the ridge 310 provides a first downward force, F₂ₐ, as the windward ridge-side is optionally off vertical by between and of 5, 10, 20, 45, or 70 degrees. A preferred off-vertical angle of the windward ridge-side 312 is 45±5, 45±10, or 45±20 degrees, which is optionally designed, as are all parameters herein, to expected wind speeds. Further, as illustrated, wind passing over a ridge 310 yields an eddy current 320 on a leeward ridge side 316. A second downward force, F_{2b}, results from the eddy current. Again, the illustrated downward forces are illustrated as point sources for clarity; an integrated downward force results from eddy forces distributed on the leeward sides of the ridges 310. In combination with additional downward forces, described infra, the first downward force, F₂ₐ, and second downward force, F_{2b}, aids in keeping the bottom side 120 of the float 100 in contact with the water 520 and to prevent the wind from stacking the floats 100 or blowing the floats 100 away altogether.

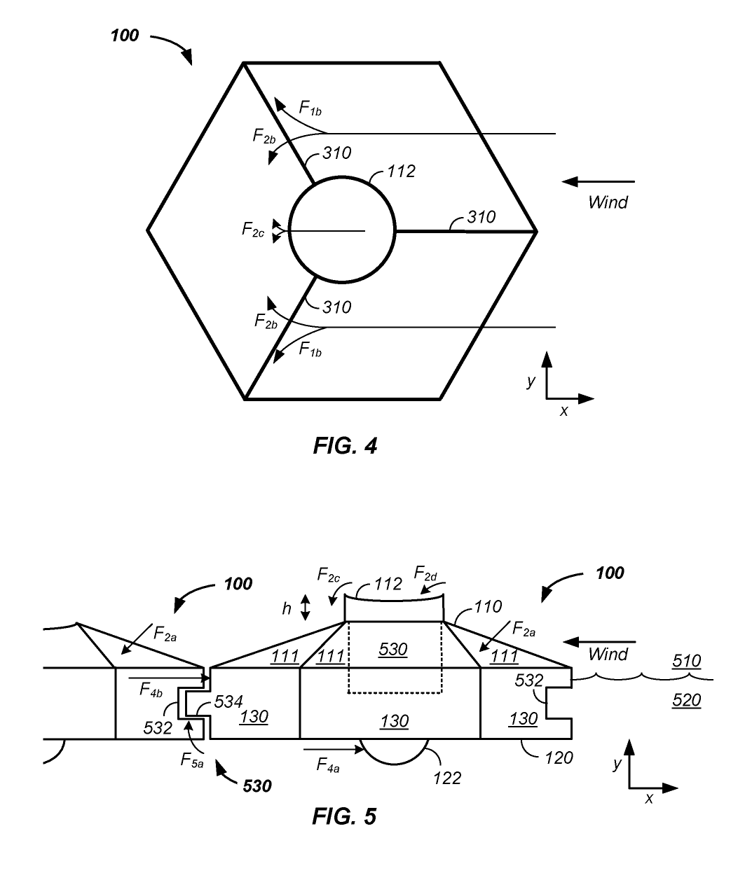

Referring now to FIG. 4 and FIG. 5, another wind driven downward force on the float 100 is illustrated. Optionally, the insert 112 protrudes or extends upward from the panels on the top surface 110 of the float 100. In a case where the insert extends above the panels, wind blowing over the insert yields a third downward force, F_{2c}, as a component of a second eddy current. The third downward force, F_{2c}, functions to stabilize the float 100 as described above for the first and second downward forces, F₂ₐ and F_{2b}. The insert 112 preferably comprises a flat upper surface, but is illustrated with a depression to form an addition ridge on the windward side of the insert 112. Generally, a generalized fourth downward force, F_{2d}, comprises any downward eddy current force resultant from airflow over a ridge.

Referring now to FIG. 5, interaction of wind forces and the stability bulb 122 are illustrated. During use, the top side 110 of the float 100 is in air 510 and the bottom side 120 of the float is in water 520. As described, supra, the stability bulb 122 comprises a rounded or teardrop shape that extends from any angled panel on the underside of the float 100 in the water 520, but is illustrated as extending from a flat bottom surface 120 of the float 100 without loss of generality for clarity of presentation. Generally, the stability bulb 120 represents any protrusion or baffle to movement of the float in water 520. As wind pushes laterally on the float 100, movement of the float is resisted by a first resistive force, F₄ₐ, resistance of the water 520 against motion of the stability bulb 120.

Further, the stability bulb 122 lowers the center of gravity of the float 100, such as to below a calm water level about the float 100, which reduces chances of the wind stacking floats vertically. Still further, the rounded bottom shape of the stability bulb 122 in combination with angled panels 111 causes a second float, driven by a strong wind or gust onto a first float, to spontaneously slide off of the first float back into the water. Thus, the self-assembled monolayer also forms after a wind event without human interaction in an automated and real-time process, which reduces costs and enhances anti-evaporation performance. A second resistive force, F_{4b}, is resistance to movement of a windward float by a leeward float.

Still referring to FIG. 5, interlocking float side elements or joints 530 are described. For clarity of presentation, a tongue 534 on a first float and a groove 532 on a second float are illustrated, which represent without loss of generality a mortise and tenon connection, a lock and key connection, a hole and tongue connection, and/or any joint connection between adjacent floats. As wind blows across the float 100, the windward side of the float 100 is at risk of lifting out of the water 520. At the initiation of the lifting of the windward side of the float 100 the groove 532 as illustrated, or tongue and groove in any case, provides a first upward resistance force, F₅ₐ, against downward movement of the tongue 534, which keeps the windward side of the float 100 in the water 520 or near the water 520 as the float 100 is optionally and preferably rigid and/or semi-rigid.

Still referring to FIG. 5, the number of grooves and floats per float is described. If a first float has six grooves it will fit and/or couple any side to a second float that has six tongues. While this is a possible case, it necessitates two types of floats and results in a low coupling efficiency. However, as the ridges 310, described supra, probabilistically orient a float, the floats are optionally configured with one or two tongues on the probabilistic leeward side and grooves on the remaining side, including the windward side. This allows a single float design where the tongue on the leeward side of a first float couples with a groove on the windward side of a second float, where the tongue and groove connection stabilizes the self-assembled monolayer of floats against waves and/or wind. Further, probability of the leeward side tongues and windward side grooves probabilistically forms a connection between each adjacent float along a first wind vector and a connection between every other float along a second wind vector varying from the first vector by 360/number of float sides degrees, resulting in a highly connected self-assemble monolayer of floats having both: (1) increased stability from the interconnections and (2) reduced evaporation of the water 520 due to the tortuous path from the water 520 through the joint 530 to the air 510.

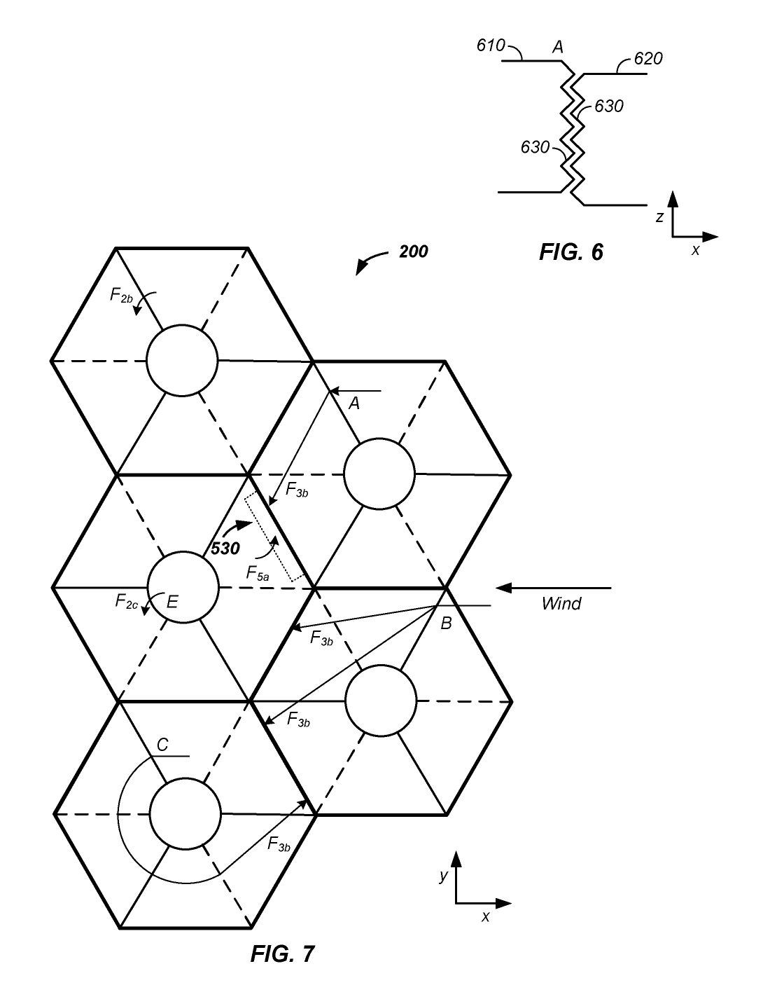

Referring now to FIG. 6, an alternative joint 530 is illustrated. As illustrated, a first float 610 and a second float 620 each have rough, multiple ridged, or saw tooth shaped sides 630. Individual saw tooth edge angles are any of zero to ninety degrees off of a vector normal to the edge or side 130 of the float 100. Generally, individual teeth of the saw are of any geometric shape, such as straight or curved. Optionally, the saw tooth joint is vertical, horizontal, or any angle therebetween. An advantage of saw tooth sides on the floats is that all sides of the floats optionally have the saw tooth shape allowing any side of the first float 610 to lock into any side of the second float, which allows up to n connections of an n-sided float with adjacent floats, where n is a positive integer of 3, 4, 5, 6, or more. The interlocked saw tooth shaped edges of the floats interact to form many resistance forces, such as a force for each tooth, against the floats lifting out of the water as a result of wind and/or wave forces.

Referring now to FIG. 7, interlocking forces between floats is further described. Referring now to a point on a ridge impeding wind, point A and point B, wind pushing on the ridge forms a second rotational force, F_{3b}, that pushes the float toward 1, 2, or more leeward floats. Further, the second rotational force may rotate the first float into a windward float as illustrated at point C. Thus, each ridge 310 of each float 100 is used to redirect a wind force to form interlocking float forces rotationally interlocking downwind and/or upwind floats to form a self-assembled monolayer of floats.

### Float Sensors

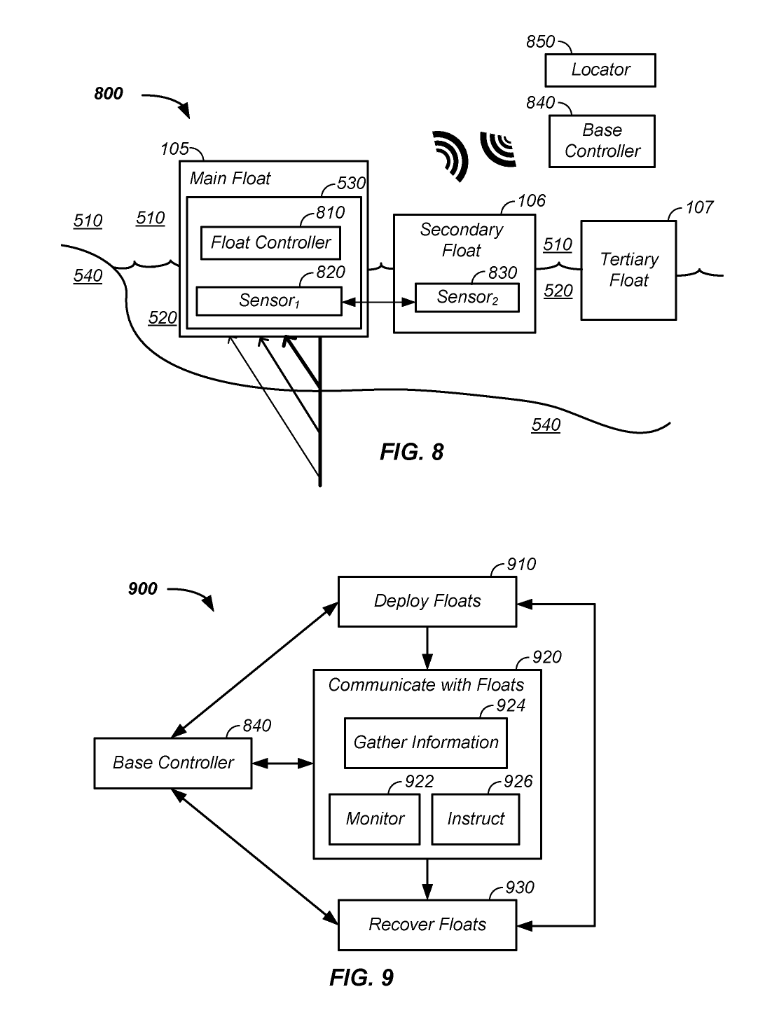

Referring again to FIG. 5 and referring now to FIG. 8, the optional float insert 112 is further described. The float 100 is optionally configured as a main float 105, secondary float 106, or tertiary float 107, which are each described herein.

Still referring to FIGS. 5 and 8, the main float 105 is optionally a float 100, where the generic float 100 is also referred to herein as a dumb float or tertiary float 107 for disambiguation and clarity of presentation, that further comprises the insert 112, an additional float element, and/or an inner compartment 530. The inner compartment 530 of the main float 105 is preferably contained in the insert 112, but is optionally within the body of the main float 105. The inner compartment 530 contains one of more of:
a power supply;
a float controller 810, which optionally further comprises a communicator; and
a first sensor 820, which is optionally a set of sensors.

In an optional and preferred case, the insert 112 contains the inner compartment 530 and the insert 112 is replaceably inserted into a float to form the main float 105. Optionally, a tertiary float is cut open, such as with a laser, the insert 112 is inserted into the tertiary float 107 to form a main float 105, and is optionally resealed, such as with the laser. The secondary float 106 is distinguished in manufacturing as comprising a secondary insert with fewer and/or different components than a main insert in the main float 105. For example, the main float 105 preferably contains the float controller 810 that gathers information from a secondary insert, such as a second set of sensors 830, contained in one or more secondary floats 106. The float controller 810 thus aggregates information from localized secondary floats 106 and communicates the aggregated data, signal, or information to the base controller, described infra. Secondary floats 106 optionally receive information from a locator 805, as described infra, and/or communicate directly with the base controller. In a case where the secondary float 106 contains all of the elements of the main float 105, the secondary float 106 is referred to as a main float 105.

The system preferably contains a full function main float 105, multiple reduced functionality secondary floats 106, and a large numbers of tertiary floats 107 at each water body. However, the system optionally contain multiple main floats 105 that each communicate with the base controller 840 from a given location. Preferably, a single main controller 105, a relatively small number of secondary floats 106, such as less than 2, 5, 10, 20, 50, 100, 1000, or 10,000; and a large number of tertiary floats, such as more than 50, 100, 500, 1000, 10,000, or 100,000 floats are deployed at each water body and the base controller communicates with the single main float 105 at each water body. However, any number of any type of float is optionally deployed at each water body. Further, optionally any type of float communicates with the base controller 840 or locator 850.

Optionally and preferably, the main float 105, secondary float 106, and tertiary float 107 appear the same or similar from a distance in terms of size, shape, and/or buoyancy to discourage theft of the more expensive main or secondary floats 105, 106. For example, the main float 105 and/or secondary float 106 are optionally configured with additional internal buoyancy relative to the tertiary float 107 to yield an approximately common buoyancy, such as differing from the tertiary float buoyancy by 1, 2, 5, 10, 15, 25, or 50 percent. The relative buoyancy is optionally achieved by leaving a hole in the tertiary buoyancy to flood an internal compartment. Optionally, the heavier floats, such as the main float 105 and/or the secondary float 106, are elongated along the z-axis in a manner where the extra contained air results in extra buoyancy, so that the main float 105 and/or secondary float 106 have an upper surface rising out of the water to a level approximating that of the tertiary float 107, which is a theft deterrent as the heavier floats are not readily recognized once deployed. The heavier floats are optionally configured with a light, bell, or indicator that is activated by a command from a controller, so that the controller may readily locate the equipment bearing floats.

### Float Sensor

Referring now to FIG. 8, the floats 100 are optionally configured in a communication system 800, where data and/or information gathered from one or more floats at one or more locations is relayed and/or communicated with one or more base controllers 840. The float controller 810 optionally and preferably gathers and/or centralizes output from one or more sensors, such as from: (1) a first sensor 820 or first set of sensors in the main float 105 and/or (2) a second sensor 830 or second set of sensors in one or more secondary floats 106. Any sensor is optionally connected, preferably wirelessly, to a locator 850 to determine position, such as a local system or a more global system, such as a global positioning system. The float sensors optionally measure any of:
daylight, which tells if the float 100 has flipped upside down and/or has sunk;
light penetration into the water 520, which is an indicator of local float coverage on the surface of the water;
   wavelengths and associated intensities of light;
a water current;
water depth, such as with sonar;
sub-surface obstructions, such as with sonar;
temperature, such as surface and/or water temperature;
conductance;
impedance;
water turbidity, such as via a particle or particulate meter;
a chemical or class of chemicals presence and/or concentration via a chemical sensor.
sound;
a magnetic field, such as via a magnetometer; and
radiation, such as with a Geiger counter.

The float controller 810 is powered through one or more of:
solar power, such as via a solar panel in and/or on the insert;
a battery, such as in the insert; and
converted wave motion.

The float controller 810 optionally communicates through use of any of:
a Wi-Fi device;
a Li-Fi device;
an acoustic device;
Bluetooth;
a directly wired connection; and
wireless communication.

### Float Deployment

Referring now to FIG. 9, a method of float use 900 is described. In a first task, floats are either manually or automatically deployed 910, such as via dumping or placing the floats in the water 520. In a second task, the float 100: (1) gathers data or monitors 922 a parameter; (2) receives instruction 926, such as from the base controller 840 and/or main float 105; (3) gathers information 924, such as from the secondary floats 106; and/or (4) passively functions as an evaporation barrier. In a third task, the base controller 840 communicates 920 with the floats 100. In a fourth task 930, the floats 100 are recovered from the water body and are optionally later redeployed at the same site or at another site.

### Float Communication

Still referring to FIG. 9, the float controller 810/base controller 840/locator 850 communication system is optionally interfaced into a command and control system or a cloud-type interface for sending and/or receiving information 112, such as information about current deployment or storage location of the floats 100. For example, the floats 100 optionally transmit position, such as a global positioning system (GPS) position obtained with a global positioning system receiver and/or status to the base controller 840 via a satellite. Similarly, the base controller 840 and the locator 850 and/or a wireless communication system is optionally used to transmit instructions to one or more of the floats 100, such as the main float 105 or secondary float 106 or the main float 105 relays information back to the secondary float 106, such as to activate a location indicator for retrieval. The base controller 840 is optionally configured to digitally overlay maps, such as terrain, onto represented locations of the deployed floats 100.

### Float Stacking

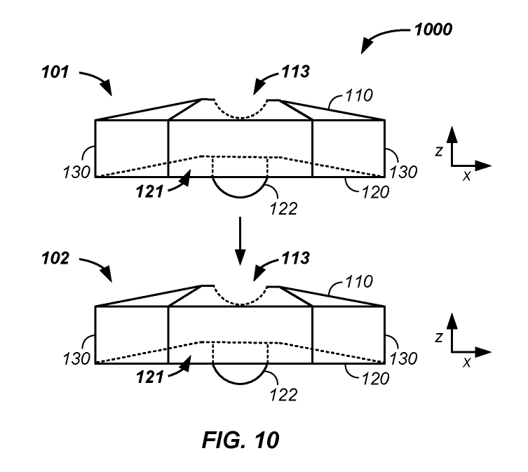

Referring now to FIG. 10, optional stackable floats 1000 are illustrated. A first stackable float 101 and a second stackable float 102 optionally contain surfaces that match or couple, when fit together. As illustrated a bottom of the first stackable float 101 matches a top of the second stackable float 102 in a manner reducing the overall stacking height, such as during transport, which allows stacking n floats, where n is a positive integer. Similarly, two floats optionally mesh together or couple together to reduce overall volume along any axis.

### Example I

Still referring to FIG. 10, without loss of generality and to clarify the invention, a first example of interfacing surfaces to reducing stacking volume is described. As illustrated, the stability bulb 120 on the bottom surface 120 of the first stackable float 101 inserts into an indentation 113 of the top surface 110 of the second stackable float 102, which reduces unpacked space between the first stackable float 101 and the second stackable float 102 during transport.

### Example II

Still referring to FIG. 10, without loss of generality, a second example reducing packing volume, resulting in decreased shipping costs is provided. As illustrated, a raised center bottom 121 of the bottom surface 120 of the first stackable float 101 inserts couples with the sloping top surface 110 of the second stackable float 102, which reduces unpacked space between the first stackable float 101 and the second stackable float 102 during transport.

Optionally, both: (1) the stability bulb 120 to indentation 113 coupling and (2) the raised center bottom 121 to sloping top surface 110 coupling are used at one time. More generally, any geometry of a first surface of one float coupling with any geometry of a second surface of another float resulting in reduced shipping volume, ease of handling, and/or automatic loading/unloading is used.

Generally, for a float with height h, geometry of stacking allows the total height of n floats to be at least 2, 5, or 10 percent less than the quantity n×h, where n is a positive integer of at least two.

Still yet another embodiment includes any combination and/or permutation of any of the elements described herein.

Herein, a set of fixed numbers, such as 1, 2, 3, 4, 5, 10, or 20 optionally means at least any number in the set of fixed number and/or less than any number in the set of fixed numbers.

Herein, any number optionally means the cited number plus or minus 1, 2, 3, 5, 10, 25, 50, or more percent.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

In the foregoing description, the invention has been described with reference to specific exemplary embodiments; however, it will be appreciated that various modifications and changes may be made without departing from the scope of the present invention as set forth herein. The description and figures are to be regarded in an illustrative manner, rather than a restrictive one and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. A method for reducing evaporation from a body of water in the presence of wind, comprising the steps of:
providing a primary float, comprising:
a top;
a bottom;
a set of sides joining said top to said bottom;
a set of ridges running radially outward along said top of said float toward an outer perimeter of said float; and
a first ridge, of said set of ridges, protruding from said top of said float by at least two millimeters; and
the wind striking the first ridge providing a first rotational alignment force, about a vertical axis, to said float when deployed on the body of water.

2. The method of claim 1, further comprising the step of:
the wind striking a second ridge on said top of said float resultant in a second rotational alignment force about the vertical axis, said second rotational alignment force rotationally opposite said first rotational alignment force.

3. The method of claim 2, further comprising the step of:
the wind passing over said first ridge providing a first downward Eddy current force on said top of said float.

4. The method of claim 3, further comprising the steps of:
a stability bulb, extending downward from said bottom of said float, both:
lowering a center of gravity of said float below a calm water line of the body of water; and
providing a first resistive force to lateral movement of said float driven by the wind.

5. The method of claim 4, further comprising the step of:
blow forming said float, said step of blow forming providing a water-tight inner compartment of said float.

6. The method of claim 4, further comprising the step of:
using a wireless communicator in said primary float to communicate with a base station on land.

7. The method of claim 6, further comprising the step of:
using said wireless communicator in said primary float to communicate with a secondary float, said primary float and said secondary float members of a set of floats.

8. The method of claim 7, further comprising:
using a sensor in said secondary float to measure a non-water chemical substance in the body of water.

9. The method of claim 7, further comprising the step of:
deploying said set of floats onto said body of water, said set of floats comprising at least five hundred tertiary floats, said tertiary floats not comprising any of: a communication device and a sensor.

10. The method of claim 9, said primary float comprising a ballast not present in said tertiary floats.

11. An apparatus for reducing evaporation from a body of water in the presence of wind, comprising:
a float, comprising:
a top;
a bottom;
a set of sides joining said top to said bottom; and
a set of ridges running radially outward along said top of said float toward an outer perimeter of said float; and
a first ridge, of said set of ridges, protruding from said top of said float by at least two millimeters,
wherein during use the wind provides a first rotational alignment force, about a vertical axis, to said float when deployed on the body of water.

12. The apparatus of claim 11, said set of sides comprising:
at least two sides; and
less than ten sides.

13. The apparatus of claim 12, said set of ridges further comprising:
a second ridge protruding upward from said top of said float by at least two millimeters,
said first ridge extending longitudinally outward toward a first side of said set of sides,
said second ridge extending longitudinally outward toward a second side of said set of sides, wherein said first side does not directly connect to said second side.

14. The apparatus of claim 13, further comprising:
a set of grooves extending longitudinally, within fifteen degrees of horizontal, along at least a first side of said set of sides;
a set of elongated protrusions extending longitudinally, within fifteen degrees of horizontal, along at least a second side of said set of sides.

15. The apparatus of claim 14, each of said set of grooves and said set of elongated protrusions comprising at least two members.

16. The apparatus of claim 13, further comprising:
a stability bulb extending radially downward from said bottom of said float along a vertical axis passing through a geometric center of said float.

17. The apparatus of claim 16, said top of said probe further comprising:
a sloped surface from a raised center of said top of said float down to said outer perimeter of said float.

18. The apparatus of claim 17, said float further comprising:
at least one water-tight compartment; and
a wireless communication device inserted into said water-tight compartment.

19. The apparatus of claim 18, further comprising:
a first sensor attached to said float configured to measure a property of the body of water; and
a second sensor attached to said float configured to measure a property beneath said water.

20. The apparatus of claim 17, further comprising:
a light meter orientated to provide a measure of sunlight passing around said float into the body of water.

21. The apparatus of claim 11, said float further comprising C₃ rotational symmetry about a vertical axis and not C₆ rotational symmetry about the vertical axis.
